(19) United States
(12) Patent Application Publication
(10) Pub. No.: US 2019/0147400 A1
(43) Pub. Date: May 16, 2019

(54) Inventory Management Software System

(71) Applicant: Paul Knight, Spokane, WA (US)

(72) Inventor: Paul Knight, Spokane, WA (US)

(21) Appl. No.: 16/181,314

(22) Filed: Nov. 5, 2018

Related U.S. Application Data
(60) Provisional application No. 62/584,879, filed on Nov. 12, 2017.

(51) Int. Cl. G06Q 10/08; G06Q 30/06

(52) U.S. Cl. CPC G06Q 10/0875; G06Q 30/0282; G06Q 30/0635

(57) ABSTRACT

A novel inventory management system is described allowing multiple workgroups to share data for their collective benefit. A server and client device communicate allowing a user within a workgroup to create items and store item data. Within a workgroup users input quotes for the item and purchasing data. A server matches items from different workgroups. When contemplating a potential purchase for an item, the inventory management system leverages the data from all workgroups to help enable the user to select a vendor with the maximum value to their respective business. The present invention reduces the time and energy in finding new vendors and lower prices for shared items.

### CROSS REFERENCE TO RELATED APPLICATION

This application claims the benefit of pending U.S. provisional application Ser. No. 62/584,879 filed Nov. 12, 2017 by the present inventor, which is incorporated by reference in its entirety.

### STATEMENT REGARDING FEDERALLY SPONSORED R&D

Not related to this application.

### TECHNICAL FIELD

This invention relates to software based inventory management systems, and more particularly to a software based inventory management system wherein workgroups share data such as pricing and vendor information.

### BACKGROUND OF THE INVENTION

Inventory management systems are common in the art of business software. They are also commonly referred to as manufacturing resource planning “MRP” software and may be embedded into an enterprise resource planning “ERP” software system. Common in the art of manufacturing, inventory management systems manage items to be purchased, building or assembly of products, shipment of products to customers, and inventory levels of items.

It is not uncommon for a manufacturing company to have tens, or hundreds, of raw material items that they must purchase in the process of building a single version of a product to a customer. Wherein even a small company many have a hundred or more finished goods products they sell, the result can be a very large number of raw materials that must be managed by the company.

Most companies want to make more profit by either increasing revenue or reducing costs. Although ideally a business will be focused on both, most small businesses do not have the time, have the systems, or give priority to reducing costs by managing purchased items. Purchased items often make up a large amount of a company's costs and because costs may be spread over so many items, it can be difficult for buyers to reduce costs across all of their raw material items. Finding new vendors and negotiating price reductions is a time-consuming and expensive process.

Prior art inventory management systems are deployed as an onsite service or a multi-workgroup software-as-a-service “SaaS” cloud based solution. Many large companies with data security concerns opt for isolated onsite versions that remain in their physical control. Small business, without the ability to fund and manage expensive onsite installations, most often choose SaaS implementations. Existing SaaS inventory management software systems isolate the data of workgroups, or accounts, to provide the same type of service and data security as onsite implementations but can support many workgroups at a lower cost. One workgroup never accesses the data of another.

Although data security is valuable, existing inventory management systems fail to provide the value of both data security and controlled sharing of data between workgroups. Prior art inventory management system fail to leverage controlled data sharing to reduce costs across all of its users. Prior art inventory management systems, both onsite and SaaS, fail to leverage vendor information and pricing information of common items across workgroups to allow all workgroup buyers to more efficiently lower costs. Prior art inventory system, both onsite and SaaS do not aggregate demand for common components to allow one workgroup that purchases a high volume of an item to potentially become a vendor to another workgroup that purchase much less. Prior art systems isolate workgroups, or accounts, and fail to appreciate the collective power of all their users.

### BRIEF DESCRIPTION OF THE DRAWINGS

Preferred embodiments of the invention are described below with the reference to the following accompanying drawings:

FIG. 1 is a flow diagram, of the present invention, showing how multiple accounts, or workgroups, each with their own users and vendor base, interact with a server containing the inventory management software by means of their own client device.

FIG. 2 is a flow diagram for a single account, wherein they wish to source or purchase one of their items from one or more of their vendors.

FIG. 3 is a flow diagram showing for a single account, the process of creating a job that utilizes a bill-of-material comprised of plurality of items.

FIG. 4 is a flow diagram showing for a single account, the process of transacting an item.

FIG. 5 is a diagram showing the general structure of a transaction record within the database of the server of FIG. 1 and showing example transaction record attributes, or data fields.

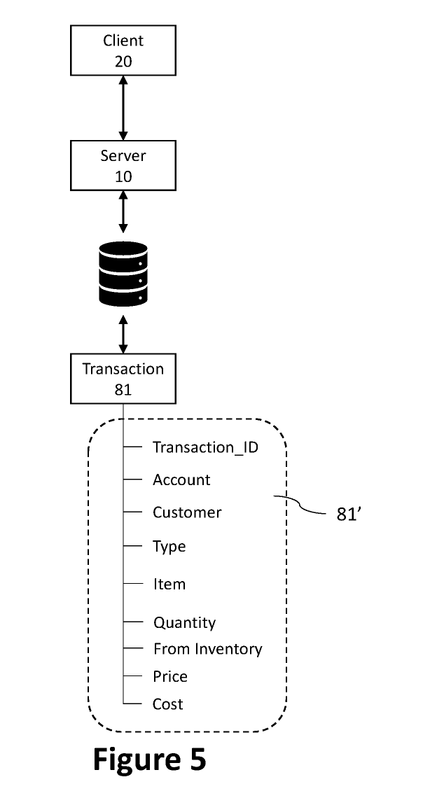

FIG. 6 is a diagram showing the general structure of a purchase record within the database of the server of FIG. 1 and showing example purchase record attributes, or data fields.

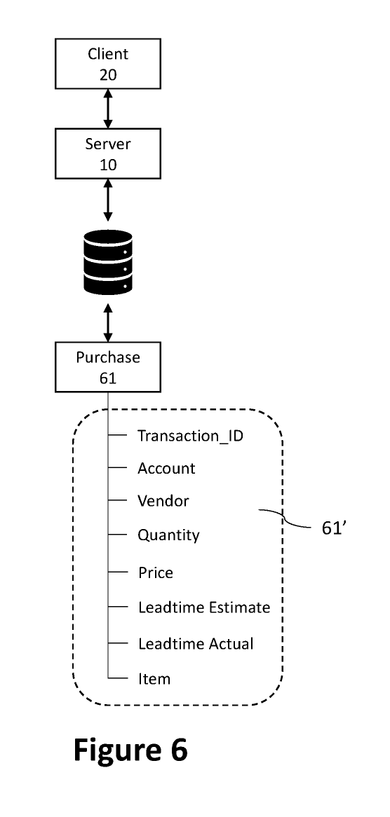

FIG. 7 is a diagram showing the general structure of an item record within the database of the server of FIG. 1 and showing example purchase item attributes, or data fields.

FIG. 8 is a diagram showing the general structure of a price list record within the database of the server of FIG. 1 and showing example price list record attributes, or data fields.

FIG. 9 is a diagram showing the general structure of a bill-of-material record within the database of the server of FIG. 1, and the dependency of a higher level item, a job and a bill-of-material.

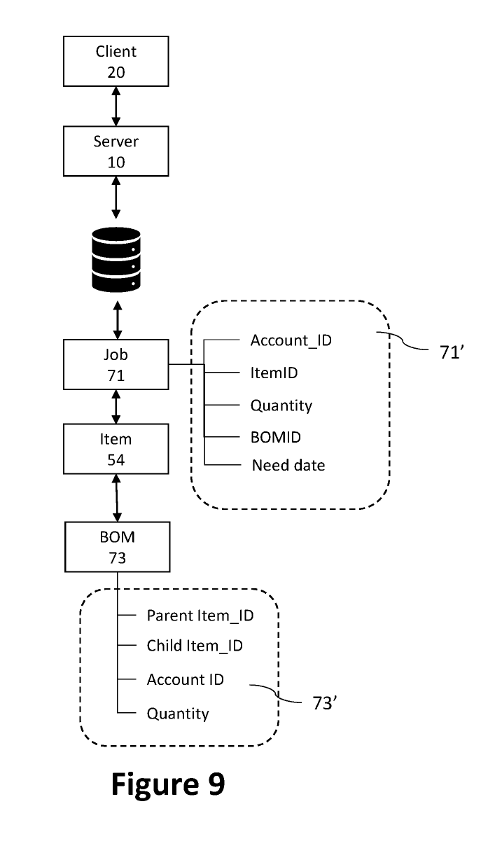

FIG. 10 is a diagram showing basic components of the server of FIG. 1.

FIG. 11 is a diagram showing the basic components of a client device that a user interacts with to communicate to the server of FIG. 1.

FIG. 12 is a flow diagram showing the process of creating a purchase screen of FIG. 15.

FIG. 13 is a flow diagram showing the process of finding alternative vendors for a proposed purchase by a user within the present system and for display within the screen of FIG. 15.

FIG. 14 is a flow diagram showing the process for proactively finding opportunities to provide users alternative vendors and sources for items.

FIG. 15 is diagram showing an example vendor selection screen for a purchase by a user within the best mode of the present invention.

FIG. 16 is a flow diagram showing how a vendor business can be search for a part that they may wish to provide a new quote on.

FIG. 17 is a flow diagram showing the process of automatically finding alternative vendors and updated pricing for items within the present invention.

### SUMMARY OF THE INVENTION

The present invention relates to an inventory management software system and more particularly to an inventory management software system wherein multiple organization, or workgroups, can share data for their collective benefit.

The present invention is a multitenant software-as-a-service (“SaaS”) system that allows different businesses accounts to manage their own respective inventory. Managing inventory is comprised of activities such as purchasing items from vendors, building items through the use of bill-of-materials (“BOM”s), and transacting items to customers. Such systems are typically referred to as inventory management systems, or manufacturing resource planning (“MPR”) or enterprise management systems (“ERP”). Rather than isolate data between user accounts, or create separate databases for each account, the present invention uses data across the accounts for the benefit of each account. Sharing data provides the ability to share vendor sources, vendor performance, pricing information and other benefits.

An object of the present invention is to allow a user in one workgroup to leverage the purchasing data of another workgroup for a common item.

An object of the present invention is to allow a workgroup to rate a vendor that may be common to multiple vendors to keep that vendor accountable to a high level of service.

An object of the present invention is to allow a user to quickly find alternative vendors for an item within their own account.

An object of the present invention is to aggregate all demand and history for an item across all workgroups so that risk and pricing can be optimally assessed by a vendor.

An object of the present invention is to reduce the time and expense for a buyer to reduce costs across a large number of purchased items.

Yet another object of the present invention is to provide automatic and real-time pricing data of items within the system.

These and other features, aspects, and advantages of the present invention will become better understood with regard to the following description, appended claims, and accompanying drawings.

### DETAILED DESCRIPTION OF THE PREFERRED EMBODIMENTS

Many of the components utilized in this invention are widely known and used in the field of the invention, and their exact nature or type is not necessary for a person of ordinary skill in the art or science to understand the invention; therefore they will not be discussed in detail.

As used herein, the term “user” is meant to represent a subset, or workgroup, of data within the software system. A user may be a person, an account, or entity, that conducts business transactions and makes their data available to the software system of the present invention. A business account, may have a single user login that is shared by all users within that account. Alternatively, users within a business account, may have separate logins that provide access to the data for their account.

As used herein, “system data” is the collective account data which is outside of a particular user or workgroup account in reference. To a particular account or workgroup, all other data is “system data”.

As used herein, “shared” or “sharing” data, is used to describe an account or workgroup giving permission for the system of the present invention to utilize the workgroup's data to create value. The “shared data” may be directly accessed by other accounts, such as vendor reviews and transaction ratings. In other instances, “shared data” may be manipulated into a calculation to provide a result, such as total usage of an item across all account transactions.

Inventory management systems, also commonly referred to as material resource planning (“MRP”) or enterprise resource planning (“ERP”) systems, are software systems that enable businesses to manage, buy, build and transact items. Prior art inventory management systems are either deployed as on-premise software or hosted in the cloud as a multi-tenant system. In both models, traditional systems isolate the data within accounts. Unlike the prior art, and according to the present invention, data is shared by accounts in the system with the goal of providing financial gains to the users. In business, it is desirable to maximize profitability by reducing costs. The sharing of data between accounts, according to the present invention, allows users to find lower cost, faster and more reliable sources for the items they purchase and build. The inventory management system described herein makes sourcing recommendations based upon historical data, and can also use historical data to proactively find opportunities to generate new vendors and price reductions for the betterment of users in multiple workgroups or accounts.

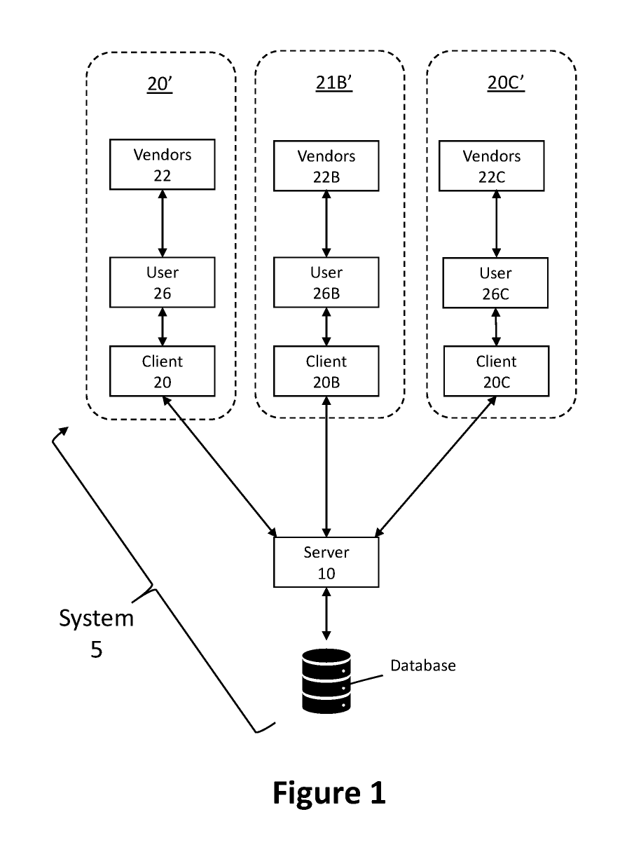

As shown in FIG. 1 and according to the best mode of the present invention, an inventory management system 5 is comprised of a server 10 that includes a database and amount of human readable and machine executable code 29. Inventory management software system 5 contains methods and delivers value by means of a server 10 processing and executing code 29. Code 29 may be written in an common language including but not limited to PHP, .net and java. Server 10 may be of any type of commonly used server in the art of computing, software and software-as-a-service “SaaS” environments. A first user 26 as part of a database workgroup 20′, with a first vendor base 22, interacts with a client computer 20 to communicate with server 10. Communication between server 10 and client device 20 is done with common communication protocols, such as but not limited to HTTP, HTTPS, FTP, SFT and the like which are common in the art of the internet. A second user 26B, within a second database workgroup 26′, which is part of a second business has a second vendor base 22B, also interacts with server 10 but through a second client device 20B. A third user 26C, within a third workgroup 26C′, within a third business has a third vendor base 22C and interacts with server 10 through a third client device 20. It should be appreciated that any number of businesses, or workgroups, may interact with server 10. It should also be appreciated that server 10 may be a single server, or a plurality of servers providing a unique function or service as part of the overall server, database and processing functionality described herein. It should also be appreciated that code 29 can partially reside on client device 20 and server 10 wherein some functions can reside as either client side code, such as javascript, or provided to client device 20 via sever side code on server 10.

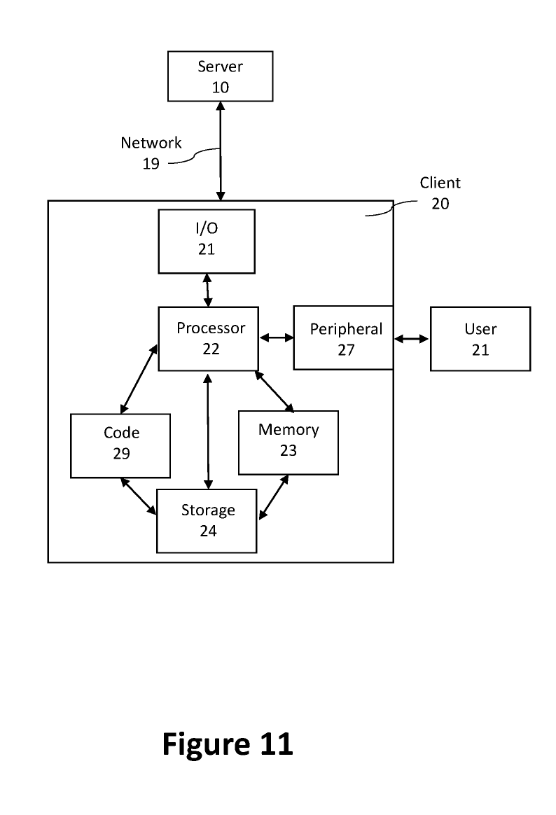

Client device 20, 20B and 20C are described in FIG. 11. Client devices are well known in the art of computing and networks and thus are not needed to be described in detail for one to understand and appreciate the present invention. Client device 20 may be a desktop computer, a tablet, mobile phone or the like. As described above, client device 20 communicates over a network 19 to server 10. Network 19 may be a wireless or wired network capable of transferring data between server 10 and client device 20. Network 19 interfaces with client device 20 though an I/O deice 21 which may provide a MAC address or IP address and is capable of transferring data to a client processor 22. Processor 22 is in communication with an amount of memory 23 and a storage device 24. Code 29 is processed by processor 22 in order to apply logic to data and deliver information to and from one or more peripheral devices 27 in which user 26 interacts. Code 29 may include a client application, or a web browser. Peripheral device 27 may be a screen, mouse, keyboard or any device capable of presenting information visually and returning instructions from a user.

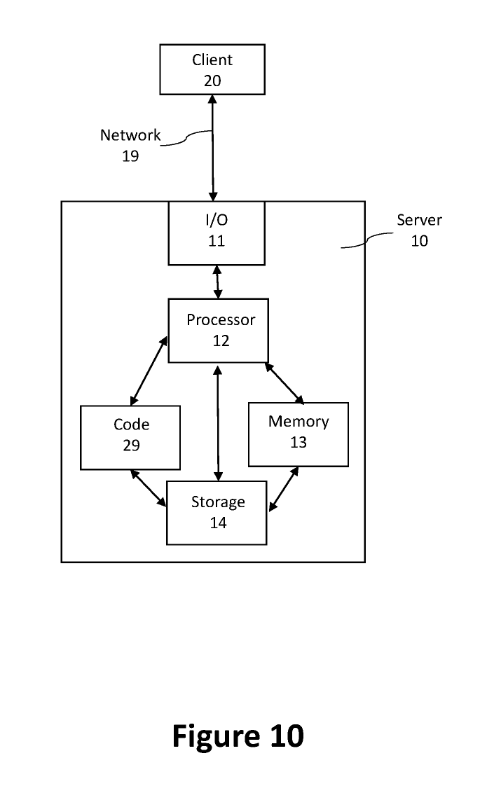

Server 10 is described at a high level in FIG. 10. Data from client 20 is received by network 19 though a server I/O device 11. Server I/O device 11, which may be a LAN card, communicates with a server processor 12. Processor 12 is able to store information in a memory device 13 and within a static storage device 14. Code 29 contains the logic described as part of the inventory management system described herein. Code 29, client device 20 and server 10 provide the means of executing the novel features and processes described herein.

The inventory management system according to the present invention provides several novel business functions, processes and methods.

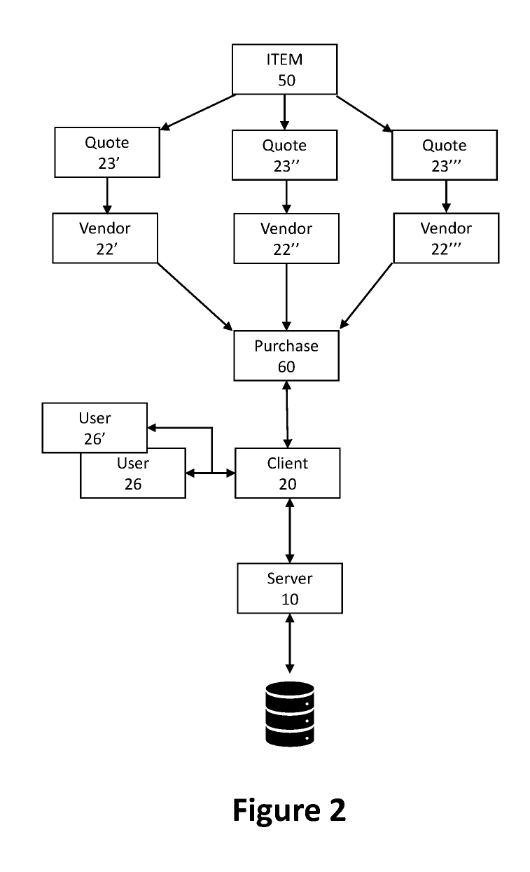

A first purchasing process is described in FIG. 2. User 26 or a same account second user 26′ within a workgroup account has purchase data for an item 50. For clarity and only as an example, item 50 may be, but is not limited to, a screw, an article of clothing, a custom fabricated item, a software program, something edible, a medical device, and the like. Item 50 represents any item that a business may purchase to resell or for its own consumption. Preferably item 50 is something that a business periodically purchases, but the present invention is also applicable to one-time purchases. A purchase 60 is created from data from one or more vendors. In the example of FIG. 2, a quote 23′ from a vendor 22′, and a quote 23″ from a vendor 22″, and a quote 23′″ from a vendor 22′″ is contemplated by user 26, wherein user 26 selects a vendor to supply item 50 for an agreed upon price and delivery date. User 26 or 26′ chooses a vendor based upon factors such as the lowest leadtime or price. Typically, a quote contains multiple prices for different quantity levels purchased. According to the present invention, purchase 60 is inputted by user 26 into client 20 and delivered as a record to server 10.

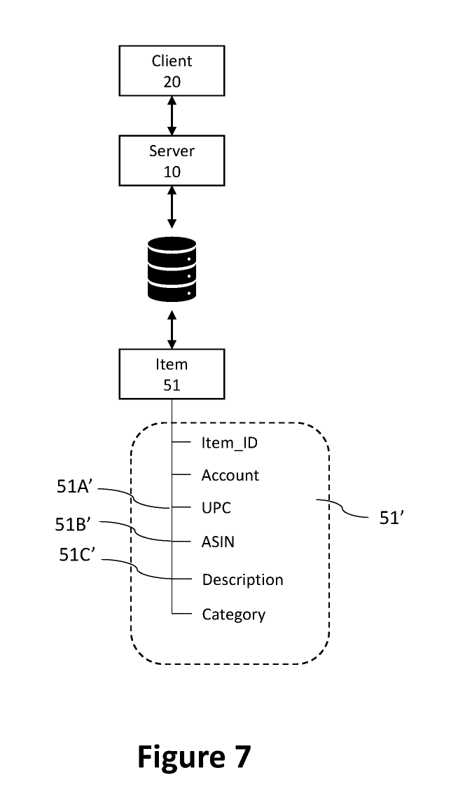

According to the present invention and as shown in FIG. 7, user 26 inputs data into server 10 to create an item record 51′. Although one item record 51′ is shown it should be appreciated that an items table 51 is a collection of individual item records. Throughout the present invention, storing data can be accomplished by a relational database or by storing document objects in a non-structured database where data keys, or identifiers, link records. Item record 51′ may have many fields, attributes, or data, including but not limited to a unique identifier such as an itemID, the account the item is associated with, a UPC number 51A′ or barcode number, the unique online selling number such as an ASIN 51B′ for Amazon, a text description 51C′ and category fields. Other fields may be useful, including but not limited to, the material the item is made from and its weight. Item record 51′ provides the means of storing data that represents an item.

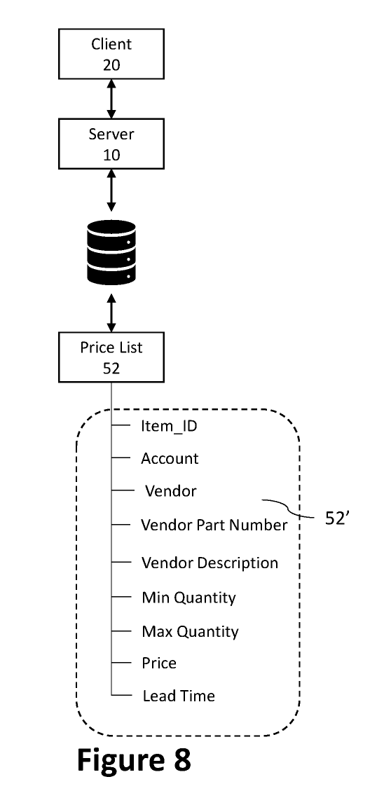

Referring back to the purchasing process of FIG. 2 and shown additionally in FIG. 8, user 26 may create a price list record 52′ that contains the vendor data for a given item. A price list table 52 represents a collection of individual price list records. Price list record 52′ may included the itemID that an individual record is referenced to, the account (or account ID) that created the entry into price list record 52′, the vendor name (or vendor ID) that the price list record 52′ corresponds to. A vendor part number is the part number the price list vendor attributes to the desired item as it is common for the business purchasing an item to have its own part number, one that is different from the vendor or manufacturer of that item. Having the vendor part number simplifies the ordering process. The vendor description may be included which is usually a text field to describe the item being purchased. Again, a vendor may describe an item differently than the company purchasing the item. Price list record 52′ also includes a minimum and may include a maximum quantity for which a price is applicable to. Many businesses provide volume discounts for increasing quantities of items being purchased. A lead time value is provided which represents the expected, or historically computed, leadtime for the vendor to deliver the item. In combination, the fields provided represent the data needed to create a sale from a vendor to a particular account within inventory management software system 5. The data within price list 52′ may come from user 26 inputting data from a quote into system 5 directly through client 20, or system 5 may create the data by enabling vendors to directly respond to a need request of an account, or alternatively, system 5 may proactively create record 52′ through web scrapping and APIs to another computer system.

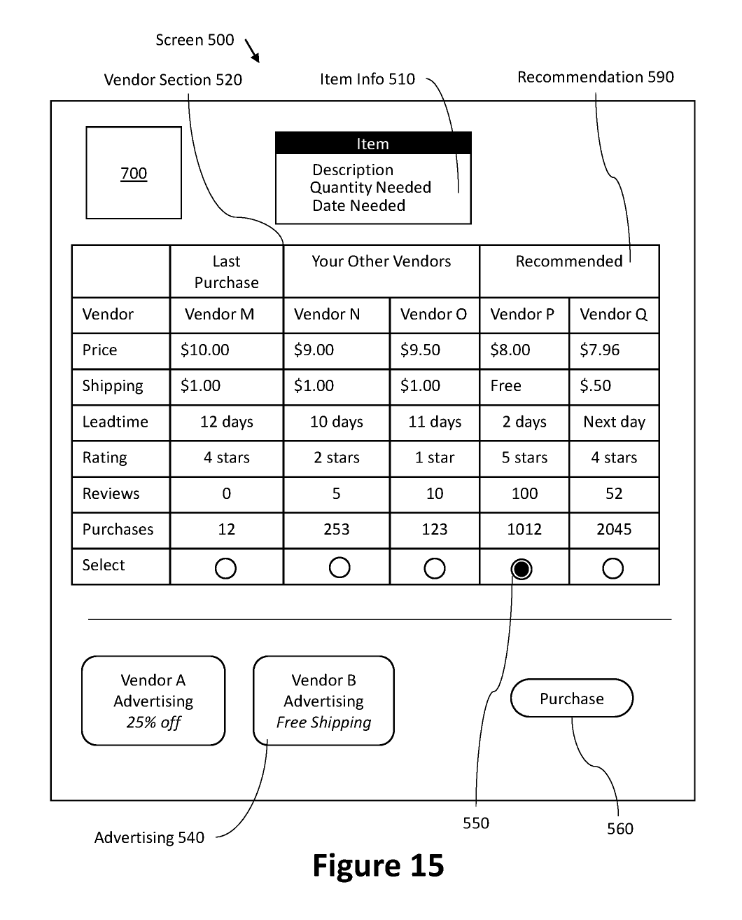

During the course of business, if a user desires to purchase more inventory of an item, they create a purchase record 61′ within a purchase table 61. A purchase screen 500 is presented to a user to find the best vendor fit for the item described within an item info panel 510. An exising vendor section 520 of screen 500 shows, via data sent from server 10 to client device 20, vendors that have a corresponding price list record within price list table 52 by searching for the itemID which is described in item info panel 510. User 26 selects the optimal vendor on screen 500 by checking a box 550 which may be any common html element such as a button, link or selector. With the optimal vendor selected, user 26 pushes a purchase button 560. FIG. 15 and the above description is provided simplified to distinctly show the method and process for choosing a vendor for the creation of a purchase. It should be appreciated there are many different user experiences and user interfaces, common in the art of software design, that can allow a user to choose a vendor and to initiate a purchase. The result of selecting a vendor and pushing button 560 is the population of data within purchase record 61′. Record 61′ may include a unique purchase identifier (or purchaseID) the account (or accountID) that created the record, the vendor (or VendorID) that the account is purchasing from, the item (or ItemID) the account is purchasing, the quantity to be purchased, the agreed upon price of each item, and the estimated leadtime for the vendor to supply the item to the account. Once item 50 is received by the account, the actual lead time can be calculated and entered into record 61′.

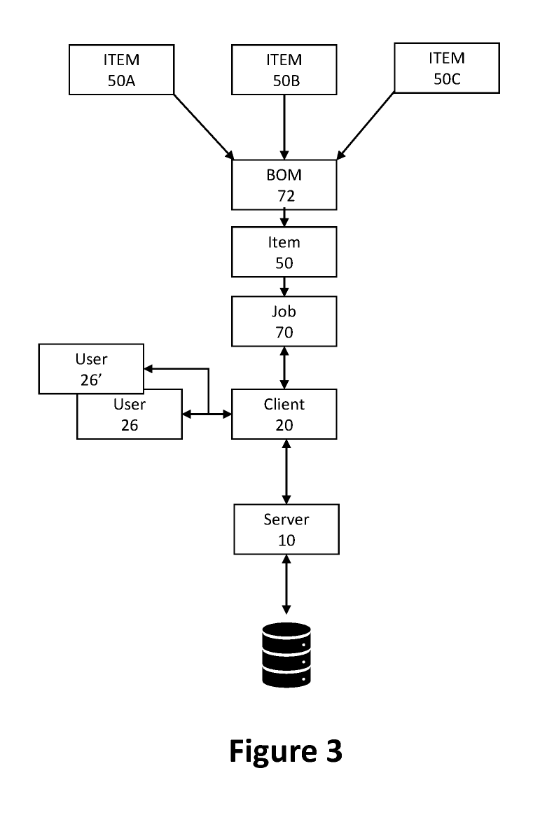

Another common business process is to create a job, for the building or assembly of an item. As shown in FIG. 3, user 26 wishes to schedule a job 70 that turns an item 50A, an item 50B and an item 50C into item 50. Item 50 may be sold directly to customers, or be a sub-assembly to be used to build another item. User 26 utilizes a BOM 72 which describes which items are part of the desired item, much like a cooking recipe. In the case of FIG. 3, BOM 72 indicates that item 50 is made from items 50A-C. User 26 inputs the data above into client 20 which sends the information to server 10. A job record 71′ is created, within a job table 71, by processor 12 and includes the account (or AccountID) the job is for, the item (or ItemID) that user 26 desires to build, the BOM (or BOMID) for that item and the date the job needs to be completed. Separately, a BOM record 73′ within a bom table 73, contains the data comprised of a BOMID for easily finding a unique bom in a relational database, the account (or AccountID) BOM record 73 is associated with, the parent item and the child item, along with the quantity of the child item per parent item. BOM structure is common in the art of manufacturing and inventory software systems and there are different ways to construct and use a BOM. It should be appreciated that multiple records within BOM table 73 may be used to create a final BOM containing multiple subassemblies (parent and child relationships). When job 70 is completed, the result is that system 5 has deducted the quantity of child items from inventory and has increased the inventory quantity of the item built.

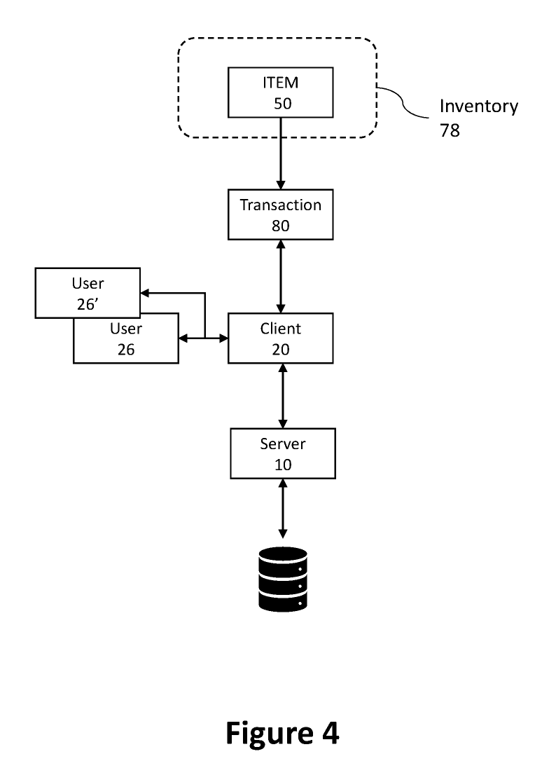

Another typical business process is described by FIG. 4. Item 50 is within an inventory location 78 and user 26 wishes to transact item 50 from inventory location 78 and move the item to a new location. The new location may be to ship the item to a customer or to scrap a bad part. A transaction 80 is created by user 26 though client 20 and the information is sent to server 10. Alternatively, transaction data can be sent directly from another computer system through an API. Server 10 takes the data of transaction 80 and creates a transaction record 81′ within a transactions table 81. Transaction record 81′ may include a unique transaction ID and the account (or accountID) that created transaction record 81′. Record 81′ may include the name of the customer if the transaction is a shipment or sale and the type of sale, such as a web, retail or distributor sale. In addition, record 81′ includes the item (or ItemID) of the item being transacted, the inventory location the item is being transacted from, the price of the item if the transaction is a sale, and the cost of the item. It should be appreciated that there are many ways to account and describe a transaction within the art of software programming, inventory management software and accounting systems. The description above is part of the best mode of the present invention.

The above descriptions of typical business processes are used to describe the best mode of the present invention. In general, a user within a company, or workgroup, has data for items, BOMs and vendors. Software system 5 provides the means to store this data for the purpose of performing business functions such as purchasing, building and transacting items. Although there are many different ways to construct databases and records, the above descriptions are provided as the best mode of the present invention, wherein inventory management system 5 stores business data for different accounts within a common database framework. User 26 enters data and instructions into client device 20 which communicates with server 10. The human readable and machine executable code 29 stored within server 10 and client device 20 contains the logic and instructions to convert the account data into useable and valuable data output. The data is used to execute the methods and to provide the value of the present invention.

Finding new sources for an item is a time consuming process and thus the cost of performing the activity can be greater than the savings. Many small businesses have limited resources and thus must give preference to customer facing activities over spending time to find new sources for items and to generate cost savings. The result is that many businesses have less than optimal profitability on their current orders. Not easily being able to reduce costs and leadtimes by finding new sources and negotiating with existing ones can keep businesses from winning new sales as their lowest profitable price may be too high to win a deal.

The goal of the present invention is to create screen 500 wherein user 26 not only can see the data that they, or their business, have stored within system 5, but system 5 can use the data of other users, workgroups and business within system 5 to provide recommendations of new vendors, negotiate new prices with existing vendors, provide vendor recommendations based upon reviews and usage of vendors by other accounts within system 5, solicit bids for an item from new vendors, to connect users with vendors through advertising and to provide real time pricing from multiple vendors. The deliverables above provide the means to reduce the cost for an item and to allow user 26 to choose a vendor that provides the most business value to their respective organization. Although the methods and value described above are used as part of the best mode of the present invention, the present invention of sharing of business data between different businesses/accounts within an inventory system present invention should not be construed to be limited to such. Shared business data may provide other business value and methods of creating it.

Referring back to FIG. 15, screen 500 contains novel features and methods for optimally choosing a vendor at the time of making a purchasing decision. Item info panel 510 shows information about the item to be purchased, potentially including the item's description, the desired quantity, and the date the item is needed by the business. Existing vendor section 520 shows past, last and existing vendors for the item, for a particular workgroup, listed in item info panel 510. Novel inventory management system 5 provides one or more columns within recommendation section 590 of screen 500. Recommendation section 590 provides alternative vendors that may be outside an accounts current vendor base 22 and provides an easy way for user 26 to find a new vendor with better performance than those listed in existing vendor section 520.

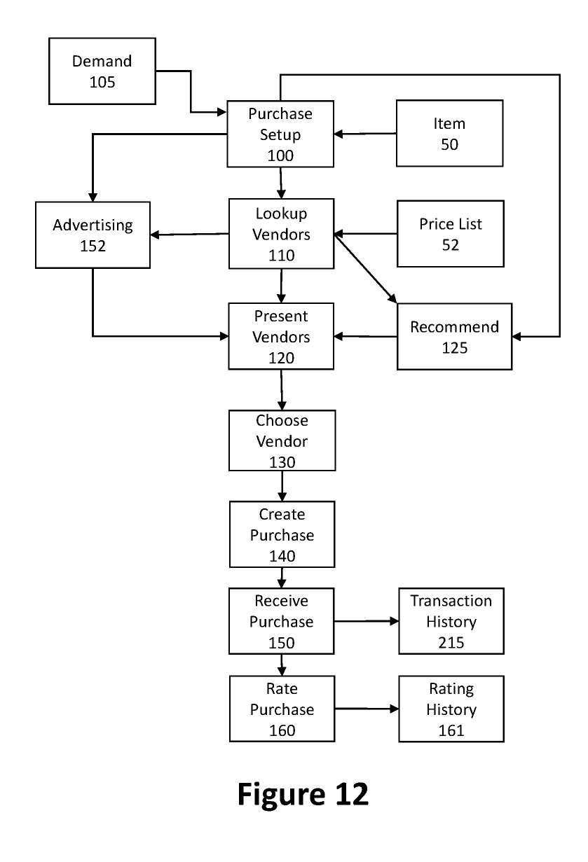

The process for inventory management system 5 to suggest vendors to user 26 via screen 500 is shown and described by FIG. 12. A user performs a purchase setup step 100 which creates item info panel 510 of screen 500. The user accomplishes this step by providing instructions to server 10 by means of interacting with client device 20. Item 50 is selected by a form or other typical HTML input method. The user may select the quantity of item 50 he or she needs for their business and provides the date that item 50 is needed. In addition to manual entry, purchase setup step 100 may be performed by system 5 by means of a demand step 105 which may use reorder points, which is when an inventory levels drop below a certain level, demand step 105 may suggest a purchase 60, to replenish a quantity of item 50. The general requirements of purchase 60 is created by purchase setup step 100. Completion of purchase setup step 100 initiates system 5 to start an advertising step 152, a lookup vendor step 110 and a recommend step 125. If it is not desired to have advertising panel 540 or recommendation panel 590 to show up on screen 500, their respective steps may be skipped by system 5. The goal of lookup vendor step 110 is to identify vendors from user 26's vendors 22. System 5 uses the identifier of item 50, and according to the present invention the unique “itemID”, to search price list table 52 for records that contain the itemID. There may be multiple matches as multiple vendors may be available for a particular user or account, as well as different pricing for different quantities for a given vendor. System 5 stores record fields, such as vendor and pricing, in memory 13 to be displayed on existing vendor section 520. A single price for the desired quantity of item 50 may be returned, or all pricing records so that a pricing table can be presented in vendor section 520 allowing user 26 to later update the desired quantity to take advantage of price breaks. Stored record fields from purchase setup step 100 and lookup vendors step 110 may be used to search for appropriate vendor advertising to display in advertising panel 540. This may be accomplished in many ways, but as a non-limiting example, advertising step 152 can be accomplished by searching vendor names and matching against requested advertisements, with advertising goal data being stored in the database of system 5. A particular vendor may wish to display their advertisement when a competitor name is to be shown in screen 500. As another example, vendors may choose to have their advertisement show up based upon certain keywords showing up in the description of item 50. Advertisement step 152 results in data and display code to be presented to screen 500 by system 5. Recommend step 125 uses information and item data from purchase setup step 100 and lookup vendors step 110, which may include item number, description, vendor names, and vendor part numbers.

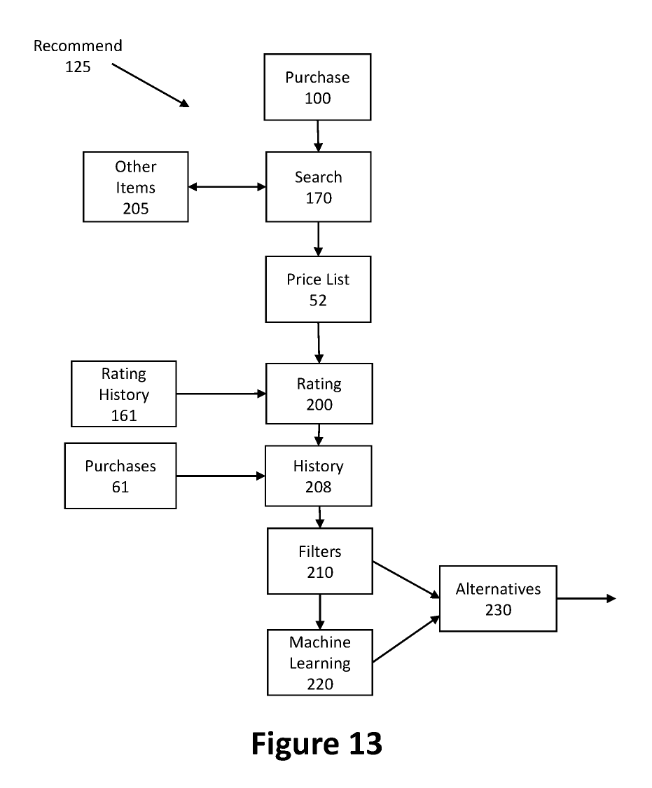

As shown in more detail in FIG. 13, recommend step 125 performs a search step 170 to find all records within item table 51, to find items of other accounts that may have similar item data, such as a similar description 51C′, UPC code 51A′ or ASIN number 51B′, as contained in item record 51′ of item 50. This can be done using common search or queries in the art of database and software programming. Other fields such as material type, category and the such can be used to identify potential item matches to item 50 and its item record 51′. The resulting matches are categorized as other items 205. Results of search step 170 are iterated with a loop within code 29 to search price list table 52 for vendors and prices that correspond with the itemID of each result. A rating step 200 is performed to pull from a rating history table 161 so that a vendor's performance history can be shown on screen 500 for each corresponding vendor. Similarly, a history step 208 searches purchase table 61 to pull data such as the number of transactions of each vendor. It should be appreciated that rating history table 161 and purchase table 61 contain records for all accounts in system 5 so that vendor performance and ratings can be shared among accounts and presented to users. The goal is to create accountability across accounts and provide additional motivation for a particular vendor to provide a high level of service to any particular account, or user, within system 5. A filter step 210 may apply user specified or system 5 specified rules to exclude certain vendors from being presented on screen 500. For example a user may want to exclude vendors outside their own state, country or a certain distance from their own business. As another example, users may choose to exclude all vendors having a rating or number of transactions below a certain threshold. An optional machine learning step 220 may apply statistical models that learn based upon past user choices to rank, or select, potential vendors. Ultimately recommend step 125 results in amount of vendor alternatives 230 that are different than exist in the user's vendor list 22. Recommend step 125 provides the means to reduce costs of user purchases leveraging the data of other users. This novel feature provides a very easy and quick way to reduce costs for a user or an account within system 5, a method that doesn't exist in prior art systems.

Referring back to the purchasing process of FIG. 12, alternative vendors 230 are stored in memory 13 for use by a present vendors step 120. Each vendor, and associated data, is sent to the user's client device which creates screen 500. Advertising data is also sent to the client device and populated in screen 500. The user then performs a choose vendor step 130 by means of selecting the most desirable vendor displayed on screen 500 as previously described. A purchase step 140 creates an actual order with the chosen vendor which may result in a paper or electronic purchase order as well as the creation of a new purchase record 61′ in purchase table 61. A receive purchase step 150 is performed when the item is received by the company, or workgroup, which through a transaction history step 215 populates the purchase record within purchase table 61 with the delivery date and increases the inventory level for the item when it is received. Comparisons between the estimated leadtime and actual leadtime of a particular vendor, or an item of a vendor, can be presented on screen 500. At any time after receive purchase step 150, the account or user that created the purchase can perform a rate purchase step 160 which populates rating history table 161. Rating history table 161 may contain the number of stars between 1 and 5, icons such as stars, a numerical rating or a review containing text. The process described above provides the means to provide an account, or a user within an account, of system 5 qualified vendor options based upon the performance, and data generated, with other accounts and users in system 5.

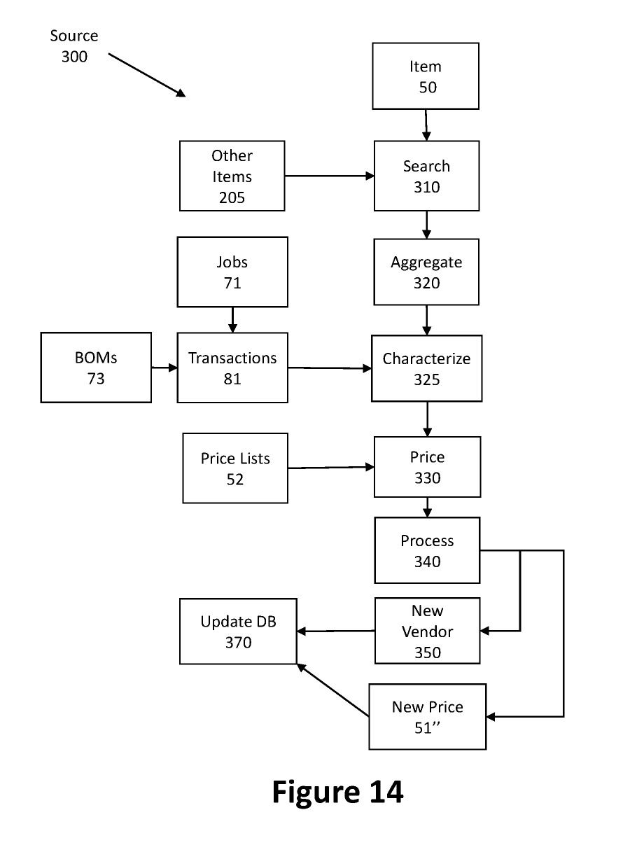

Sharing data between accounts within system 5 provides additional advantages to the user or account collective. A source process 300 is shown in FIG. 14 and is used to further provide alternative vendors, and improved pricing, to users for a given item. System 5 may retrieve in a loop fashion every item, or a group of items, within item table 51. For simplicity, the following description will be applied to a single item, item 50, but it should be appreciated that source process 300 can be applied to all items in item table 51. With system 5 selecting item 50, a search step 310 is performed by server 10. Search step 310 starts by pulling data from item record 51′ which describes item 50. Similar to the previously described recommendation step 125, system 5 searches to find matching items. This can be accomplished by matching records within purchase table 61 and price list table 51 by means of item descriptions, vendor descriptions, vendor part numbers and the like. Other items 205 is created by search step 310 and contains the itemIDs of matched items. An aggregation step 320 is then performed to combined all purchases of item 50 within purchase table 61 as to determine the combined quantity of item 50 that all users within system 5 have purchased. It is common for businesses to purchase equivalent items from different vendors. The output of aggregate step 320 is the total purchased quantity of item 50, or its equivalent, across all user accounts. It is also desirable to understand the average and distribution of order sizes across all user accounts for item 50. Aggregate step 320 indicates if there is an opportunity to save all users money by aggregating all demand. A characterize step 325 is then performed to understand the end customer demand of item 50 by searching for item 50 in transactions table 81. Characterize step 325 may also utilize searches of jobs table 71 and BOM table 73 to determine which items sold contain item 50. Understanding the number of customers across all users in system 5 for item 50, as well as the number of sales channels, provides the data needed for someone to determine the risk level for potentially purchasing large quantities of item 50 at a discounted price and to act as a distributor to all users within system 5. The output of characterize step 325 is the known demand, and historical purchase characteristics of item 50. A price step 330 is then performed to search price list table 52 to determine how the total known demand compares to known pricing across all users within system 5. Price step 330 can identify if total known demand for all users substantially exceeds the maximum quantity of any price list record for item 50 within pricing table 51, thus indicating a good opportunity to negotiate a price reduction for all users within system 5 for buyers, and potential buyers, or item 50. Price step 330 may result in the identification that some users within system 5 are purchasing item 50 at quantity levels below the levels of others, an opportunity to allow the “piggy-backing” of orders between users wherein they place one order and split the order shipment to two different addresses and both save money. Alternatively, one user purchasing large quantities of item 50 may choose to purchase a small additional amount of item 50 to act as a vendor to other users within system 5. A process step 340 can result in an alert 700 presented in screen 500 to notify users of opportunities to save money by piggy-backing, by combining orders or to supply other users with their own supply of item 50. Process step 340 may also notify users within system 5 to perform a new vendor step 350 wherein they can search and negotiate with new vendors for a price reduction for all users within system 5. A new vendor can provide data that can be inputted into the database of system 5 through an update DB step 370 so that the new vendor can be presented into screen 500 as previously described. Alternative, process step 340 may alert a user to perform a new quote step 360 to negotiate a new lower price with an existing vendor for the betterment of all users within system 5. Data of a lower price can be used to create a new price list record or new price record within the database of system 5 by update DB step 370. In addition to user performing steps 350 and 360, the identification of opportunities through process step 340 can be used by system 5 to automatically find new vendors and negotiate pricing by means of automated emails, APIs and web scrapping.

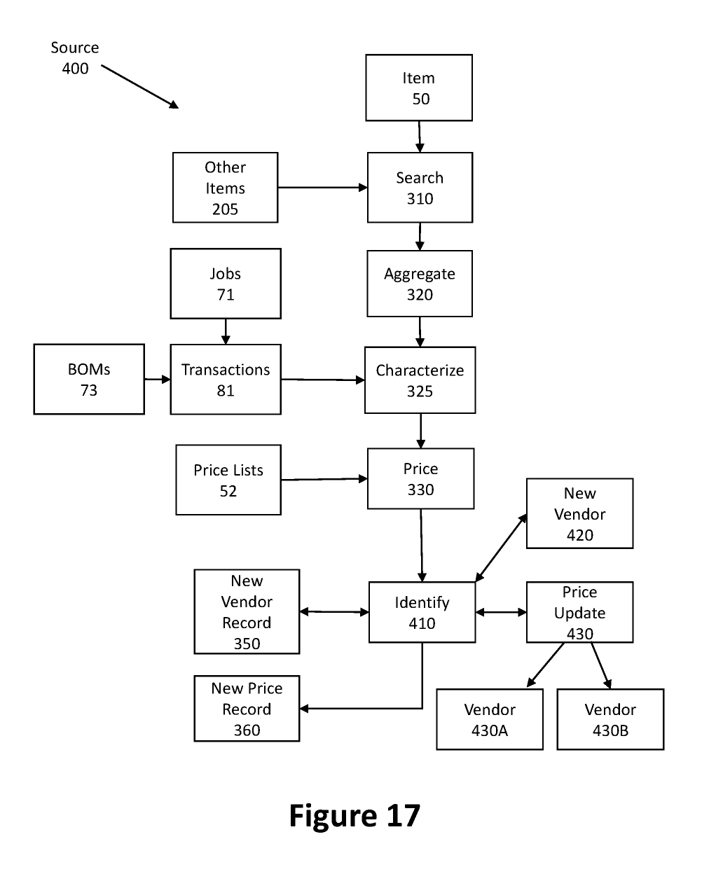

FIG. 17 shows an automatic sourcing process 400 which is similar to sourcing process 300 of FIG. 14. Instead of process step 340 notifying users for opportunities to find new vendors or prices through alert 700, an identify step 410 automatically finds new vendors and prices. Server 10 as part of identify step 410 may electronically connect with a computer system of an existing vendor and through APIs, webs scraping, or structured data interfaces, identify a new price for item 50. In the event a new price is identified, either higher or lower, new price record may be automatically created for item 50 via a new price record step 360 so that new data can be made available through the purchasing process previously described. For clarity, system 5 may automatically pull pricing data from existing vendor 430A and existing vendor 430B, wherein system 5 performs the new price record step 360 for each. Similarly, a new vendor step 420 automatically identifies if new vendors are available for item 50. Server 10, as part of new vendor step 420, may search internet data utilizing attributes and fields for item record 51. This may be done through the use of documented application programming interfaces (APIs), such as utilizing ASIN 51B′ as part of item record 51 to request and receive pricing information from a marketplace such as Amazon (a trademark of Amazon). Alternatively, identify step 410 may send UPC 51A′ “bar” code, as part of item record 51, to an internet search system to return a page containing that UPC code. Server 10, as part of identify step 410 may request the HTML data for that webpage, and then process pricing and vendor information through the use of regular expressions and structured tagging such as XML and JSON. In the event identify step 420 finds a new vendor, a new vendor record step 350 is performed to input the vendor into system 5, and new price record step 360 is performed to store pricing information. System 5 provides new vendors and real-time pricing data to users.

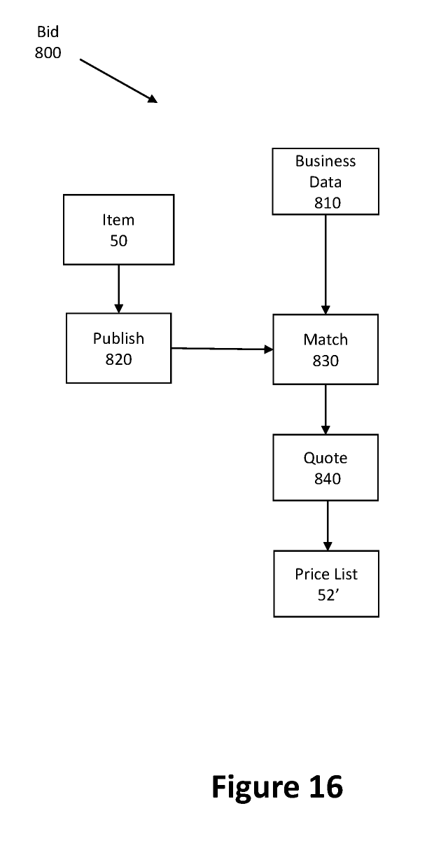

Yet another advantage of the shared data model of system 5 is a bid process 800 shown by FIG. 16. A first business data step 810 is performed to characterize the type and interest of a vendor business within system 5. Business data step 810 allows vendor users to input data and text through their client device and to have that data stored in the database of system 5. Vendor users perform data step 810 with the goal of finding items to provide new quotes for. User 26, for example, performs a publish step 820 wherein he/she agrees to give others access to their account data about item 50. A match step 830 searches the database of system 5 for matching data between the data created from business data step 810 and item records in item table 51. As a more particular example, if user 26 performs publish step 820 for item 50, system 5 takes the data from business data step 810, such as keyword interests or competitive vendor names, and system 5 searches for items that have been made available by publish step 820. Match step 320 alerts the vendor user that performed business data step 810 of an opportunity to quote item 50. A quote step 840 delivers the quote to user 26 for published item 50 by creating a new price list record 52′. Price list record 52′ may then be presented on screen 500 to any account having item 50 or a match to item 50.

While the inventory management system herein described constitute preferred embodiments of the invention, it is to be understood that the invention is not limited to these precise form of assemblies and process flow, and that changes may be made therein without departing from the scope and spirit of the invention.

I claim:

1. A computer-implemented method of purchasing within a software-based inventory management system, comprising:
a first workgroup having a first item including a first amount of item data;
a first user within said first workgroup inputting into said inventory management system at least one first item vendor and at least one first item vendor price list record;
a second workgroup having a second item including a second amount of item data, said second item having a second item vendor and an at least one second item vendor price list record within said inventory management system;
a server system matching said first amount of item data to said second amount of item data;
said first user selecting said first item from a client device and said server system returning to said client device purchasing data comprised of said first item vendor, said at least one first item vendor price list record, said second item vendor and said at least one second item vendor price list record;
said first user selecting a purchase vendor from said purchasing data;
said system creating a purchase record comprised of said first item, said purchase vendor, a purchase quantity and a purchase price; and,
said system increasing an inventory quantity for said first item for said first workgroup as a result of receiving said first item from said purchase vendor.

2. The method of claim 1, wherein said first amount of item data and said second amount of item data include a UPC code.

3. The method of claim 1, further including said first user inputting and creating a rating record for said purchase vendor within said system.

4. The method of claim 1, wherein said first item vendor price list record and said second item vendor price list record include a minimum quantity and a price.

5. The method of claim 1, wherein said first item vendor price list record and said second item vendor price list record include a lead time.

6. The method of claim 1, wherein said first workgroup utilizes said first item in a job causing said system to reduce said inventory quantity.

7. The method of claim 1, wherein said first item is structured within a bill of material.

8. A computer-implemented method of purchasing within a software-based inventory management system, comprising:
a first workgroup having a first item including a first amount of item data;
said inventory management system containing a plurality of system items each having an associated amount of system item data, a plurality of system vendors and a plurality of system price list records associated to said plurality of system items;
a user of said first workgroup selecting said first item from a client device in communication with a server system;
said server system creating one or more other items by matching said first amount of item data to said system amount of item data,
said server retrieving at least one matched vendor and at least one matched price list record for said one or more other items;
said server system returning to said client device said at least one alternative vendor and at least one price list record for said one or more other items;
said first user selecting a purchase vendor;
said system creating a purchase record comprised of said first item, said purchase vendor, a purchase quantity; and,
said system increasing an inventory quantity for said first item for said first workgroup as a result of receiving said first item from said purchase vendor.

9. The method of claim 8, wherein first amount of item data and said system amount of item data include a UPC code.

10. The method of claim 8, further including said first user inputting and creating a rating record for said purchase vendor within said system.

11. The method of claim 8, wherein said first item vendor price list record or said one matched price list record include a minimum quantity and a maximum quantity.

12. The method of claim 8, wherein said first item vendor price list record or said one matched price list record include a lead time.

13. The method of claim 8, wherein said first workgroup utilizes said first item in a job causing said system to reduce said inventory quantity.

14. The method of claim 8, wherein said first item is structured within a bill of material.

15. A computer-implemented method of managing vendors and pricing within a software-based inventory management system, comprising:
a first workgroup having a first item including a first amount of item data;
a first user within said first workgroup inputting into said inventory management system at least one first item vendor and at least one first item vendor price list record;
said inventory management system containing a plurality of system items each having an associated amount of system item data, a plurality of system vendors and a plurality of system price list records associated to said plurality of system items;
said inventory management system automatically and electronically identifying and creating records for new pricing and new vendors for said first item or said plurality of system items;
said first user selecting said first item from a client device and a server system returning to said client device said first item vendor and said at least one first item vendor price list record;
said server system creating one or more other items by matching said first amount of item data to said system amount of item data,
said server retrieving at least one matched vendor and at least one matched price list record for said one or more other items;
said server system returning to said client device said at least one matched vendor and at least one matched price list record for said one or more other items;
said first user selecting a purchase vendor;
said system creating a purchase record comprised of said first item, said purchase vendor, a purchase quantity; and,
said system increasing an inventory quantity for said first item for said first workgroup as a result of receiving said first item from said purchase vendor.

16. The method of claim 15, wherein first amount of item data and said system amount of item data include a UPC code.

17. The method of claim 15, further including said first user inputting and creating a rating record for said purchase vendor within said system.

18. The method of claim 15, wherein said first item vendor price list record or said one matched price list record include a minimum quantity and a maximum quantity.

19. The method of claim 15, wherein said first item vendor price list record or said one matched price list record include a lead time.

20. The method of claim 15, wherein said first workgroup utilizes said first item in a job causing said system to reduce said inventory quantity.
